(19) United States
(12) Patent Application Publication
(10) Pub. No.: US 2011/0261047 A1
(43) Pub. Date: Oct. 27, 2011

(54) PLASMA DISPLAY APPARATUS AND METHOD OF DRIVING PLASMA DISPLAY PANEL

(76) Inventors: Junichi Kumagai, Ibaraki (JP); Naoki Itokawa, Kanagawa (JP); Katsumi Itou, Kanagawa (JP); Masaki Kimura, Kanagawa (JP)

(21) Appl. No.: 12/679,351

(22) PCT Filed: Feb. 7, 2008
(86) PCT No.: PCT/JP2008/052061

§ 371 Date: May 3, 2010

(51) Int. Cl. G09G 3/10; G06F 3/038

(52) U.S. Cl. 345/213; 345/42

(57) ABSTRACT

A plasma display apparatus includes a plasma display panel having a plurality of sustain electrodes and a plurality of scan electrodes, a driver circuit to apply sustain pulses to the plurality of sustain electrodes and the plurality of scan electrodes to generate sustain discharges, and a control circuit to control the driver circuit such that a total light emitting pulse count defined as a total number of sustain pulses in one display frame is set equal to a predetermined pulse count defined as a function of a display load ratio, and such that the total light emitting pulse count is set lower than the predetermined pulse count upon detecting a predetermined condition, wherein the control circuit is configured to cause the driver circuit to selectively generate first sustain pulses with timing for clamping to a predetermined voltage being first timing and second sustain pulses with timing for clamping to the predetermined voltage being second timing, and configured to cause a ratio between a number of the first sustain pulses and a number of the second sustain pulses to be different between a case of the total light emitting pulse count being the predetermined pulse count and a case of the total light emitting pulse count being smaller than the predetermined pulse count.

### TECHNICAL FIELD

The present invention generally relates to image display apparatuses and methods of driving such apparatuses, and particularly relates to a sub-frame-method-based plasma display apparatus and a method of driving such a plasma display panel.

### BACKGROUND ART

Flat display apparatuses using flat display panels have been put to practical use in wide areas of application from small displays to large displays, and are replacing conventional cathode-ray tubes. In the field of large-size displays, the plasma display panel (PDP) is regarded as superior due to its advantageous characteristics derived from the principle of operation and configuration, and are commercialized as mainstream products.

FIG. 1 is a cross-sectional view of a three-electrode-type flat-plane-discharge AC-PDP panel serving as an example of a large-size display apparatus.

The three-electrode-type flat-plane-discharge AC-PDP panel includes two glass substrates, i.e., a front glass substrate 15 and a rear glass substrate 11. On the front glass substrate 15, common sustain electrodes (X electrodes) and scan electrodes (Y electrodes), each of which is comprised of a sustain-purpose BUS electrode 17 and transparent electrode 16, are formed. The X electrodes and the Y electrodes alternate with each other. A dielectric layer 18 is formed on the X electrodes and Y electrodes, and a protective layer 19 made of MgO or the like is formed on top of the dielectric layer 18.

The BUS electrode 17 has high conductivity, and serves as reinforcement for the conductivity of the transparent electrode 16. The dielectric layer 13 is made of low-melting-point glass, and serves to maintain discharge based on wall charge.

Address electrodes 12 are formed on the rear glass substrate 11 in such a manner as to extend perpendicularly to the X electrodes and Y electrodes. A dielectric layer 13 is formed on the address electrodes 12. On the dielectric layer 13, barrier ribs 14 are formed at positions corresponding to the gaps between the address electrodes 12.

Between the barrier ribs 14, phosphor layers R, G, and B are formed to cover the dielectric layer 23 and the sidewalls of the barrier ribs. The phosphor layers R, G, and B correspond to red, green, and blue, respectively. When the PDP is driven, electric discharge between the X electrodes and the Y electrodes generates ultraviolet light, which excites the phosphor layers R, G, and B to emit light, thereby displaying an image.

The gap between the front panel having the X electrodes and Y electrodes and the rear panel having the address electrodes 12 is filled with discharge gas such as a mixture of neon and xenon. Space at the position where an X electrode and Y electrode intersect with an address electrode constitutes a single discharge cell (pixel).

FIG. 2 is a block diagram showing a main part of a driver circuit for the three-electrode-type flat-plane-discharge AC-PDP panel. A driver circuit shown in FIG. 2 includes an address driver circuit 111, a scan driver circuit 112, a Y common driver circuit 113, an X common driver circuit 114, and a control circuit 115. The control circuit 115 includes a display data control unit 116, a scan driver control unit 117, a common driver control unit 118, and a power control unit 120. The display data control unit 116 includes a frame memory 119.

The control circuit 115 generates control signals for controlling panel operations based on a clock signal CLK, display data D, a vertical synchronizing signal VSYNC, a horizontal synchronizing signal HSYNC, and so on received from an external source. To be specific, the display data control unit 116 receives the display data D for storage in the frame memory 119, and generates an address control signal responsive to the display data D stored in the frame memory 119 in synchronization with the clock signal CLK. The address control signal is supplied to the address driver circuit 111. The scan driver control unit 117 generates a scan driver control signal for controlling the scan driver circuit 112 in synchronization with the vertical synchronizing signal VSYNC and the horizontal synchronizing signal HSYNC. The common driver control unit 118 drives the Y common driver circuit 113 and the X common driver circuit 114 in synchronization with the vertical synchronizing signal VSYNC and the horizontal synchronizing signal HSYNC.

The address driver circuit 111 operates in response to the address control signal supplied from the display data control unit 116, and applies address voltage pulses responsive to the display data to address electrodes A1 through Am. The scan driver circuit 112 operates in response to the scan driver control signal supplied from the scan driver control unit 117, and drives scan electrodes (Y electrodes) Y1 through Yn independently of each other. While the scan driver circuit 112 successively drives the scan electrodes (Y electrodes) Y1 through Yn, the address driver circuit 111 applies address voltage pulses to the address electrodes A1 through Am, thereby selecting cells to emit light so as to control display/non-display (selected-state/unselected-state) of each cell (pixel) 103.

The Y common driver circuit 113 applies sustain voltage pulses (i.e., sustain pulses) to the Y electrodes Y1 through Yn, and the X common driver circuit 114 applies sustain voltage pulses to the X electrodes X1 through Xn. The application of these sustain voltage pulses generates sustain discharge between an X electrode and a Y electrode at the cells selected as display cells. The address electrodes A1 through Am, X electrodes X1 through Xn, and Y electrodes Y1 through Yn are disposed between a front glass substrate 101 (corresponding to 15 in FIG. 1) and a rear glass substrate 102 (corresponding to 11 in FIG. 1). Further, barrier ribs 106 (corresponding to 14 in FIG. 1) are provided between the address electrodes A1 through Am.

FIG. 3 is a waveform diagram showing an example of a basic operation of the driver circuit of FIG. 2. The drive period of a PDP mainly consists of a reset period, an address period, and a sustain period. In the reset period, each display pixel is initialized. In the address period that follows, pixels to be displayed is selected. In the sustain period that comes last, the selected pixels are caused to emit light.

In the reset period, voltage waveforms as illustrated are applied to the Y electrodes Y1 through Yn serving as scan electrodes and to the common X electrodes X1 through Xn, thereby initializing the state of all the display cells. Namely, the cells that were displayed on a preceding occasion and the cells that were not displayed on the preceding occasion are equally initialized to the same state.

In the address period, scan voltage pulses at the −Vy level are successively applied to the Y electrodes Y1 through Yn serving as scan electrodes, thereby driving the Y electrodes Y1 through Yn one by one. In synchronization with the application of the scan voltage pulses to the Y electrodes, address voltage pulses at the Va level are applied to the address electrodes (A1 through Am). This serves to select display pixels on each scan line.

In the sustain period that follows, sustain pulses (sustain voltage pulses) at the common. Vs level (Vsy, Vsx) are alternately supplied to all the scan electrodes Y1 through Yn and the X common electrodes X1 through Xn. With this arrangement, the pixels selected in the address period are cause to emit light. The continuous application of sustain pulses then achieves a display at predetermined luminance levels.

This basic operation of applying a series of drive waveforms may be combined with other basic operations to control the number of light emissions, thereby making it possible to represent gray tones. FIG. 4 is a drawing for explaining a method of displaying gray scales based on a sub-frame method that is widely employed today.

FIG. 4 illustrates a case in which 1024 gray scales are displayed by use of 10 sub-frames. Each of 10 sub-frames SF1 through SF10 is comprised of the reset period (“RESET DRIVE TIMING” in FIG. 4), the address period, and the sustain period (“SUSTAIN DRIVE PERIOD”). Drive operations for the reset period and the address period are substantially the same between different sub-frames, but the number of sustain pulses in the sustain period differs from sub-frame to sub-frame. Sub-frames having different numbers of sustain pulses are combined together to represent a desired gray scale.

There are many ways to assign the numbers of sustain pulses to the 10 sub-frames. In general, the numbers of sustain pulses in the 10 sub-frames are set to 2⁰=1, 2¹=2, 2²=4, . . . , and 2⁹=512, respectively. Sub-frames forming a desired combination of sub-frames selected from these 10 sub-frames are caused to emit light, thereby making it possible to represent 1024 gray scales at the maximum.

In the following, the total number of sustain pulses summed over all the sub-frames of one display frame is referred to as a total light emitting pulse count. Namely, the total light emitting pulse count is equal to the number of sustain pulses used when emitting light in all the sub-frames, and is equal to the maximum number of sustain pulses that can be supplied to a single cell during a single display frame. This total light emitting pulse count is also referred to as sustain frequency.

A maximum light emitting pulse count is defined as the total number of light emitting pulses summed over all the cells constituting the entire display when all the cells are lit with the total light emitting pulse count in one display frame. A display light emitting pulse count is defined as the total number of light emitting pulses summed over all the cells constituting the entire display when an image for one display frame is displayed in response to given display data. A ratio of the display light emitting pulse count to the maximum light emitting pulse count is referred to as a display load ratio. The display load ratio is 0% upon displaying black in all the cells, and is 100% upon displaying all the cells at the maximum luminance.

Under the condition of the total light emitting pulse count being constant, power consumption increases as the display load ratio increases. In PDP, electric currents flowing during the sustain period account for a large proportion of the total consumption of electric currents. An increase in total electric current consumption is thus significant when the total number of light emitting pulses in one display frame is increased. In order to reduce power consumption, it is preferable to set the total light emitting pulse count such that the power consumption observed at the time of the maximum display load ratio, i.e., at the time of displaying all the cells with the maximum luminance level is no larger than a predetermined electric power.

The display load ratio of a typical image is in the range of some ten percent to a few ten percent, and rarely reaches 100%. A setting that is made to limit power consumption observed at the time of the maximum display load ratio (i.e., 100%) as described above gives rise to the problem in that a normal displayed image becomes dark. In consideration of this, power control is performed to change the total light emitting pulse count in response to a display load ratio, so that the display is as bright as possible as long as the power consumption does not exceed a limit.

The power control unit 120 illustrated in FIG. 2 calculates the duration of one frame (i.e., one frame length) based on the vertical synchronizing signal, and also calculates the display load ratio based on display data, followed by calculating a sustain frequency based on the calculated frame length and the display load ratio. The display load ratio may be calculated by detecting the display light emitting pulse count by counting the light emitting pixels for each sub-frame upon storing input image data in the frame memory 119 and by calculating a ratio of this display light emitting pulse count to the maximum light emitting pulse count.

The power control unit 120 as illustrated in FIG. 5 controls the sustain frequency such that total light emitting pulse count n is set to n0 when the display load ratio does not exceed A, and such that the total light emitting pulse count n is decreased to prevent power consumption P from exceeding Pmax when the display load ratio exceeds A. The decreased total light emitting pulse count n may be allocated, as sustain pulses, to the sub-frames according to a predetermined ratio. Namely, when there are 10 sub-frames, for example, the total light emitting pulse count n is allocated to each sub-frame according to a ratio of 1:2:4:8:16:32:64:128:256:512.

In PDP, the light emission and electric discharge of each cell generates heat, with the amount of generated heat being proportional to the number of light emissions per unit time. In the case of a display pattern which has a bright spot in a localized area, the generation of large heat quantity in the localized area may damage the panel. Such a pattern that causes thermal damage is a still image having high contrast, for example. Even if thermal damage is not brought about, the prolonged presentation of such a pattern may cause a phenomenon referred to as “burning”, by which phosphor at the displayed spot degrades.

Addressing the problems described above, Patent Document 1 discloses a technology that reduces sustain frequency upon determining that there is a risk of thermal damage when there is a prolonged period of large sustain frequency (i.e., total light emitting pulse count). Also, Patent Document 2 discloses a technology that monitors a display load ratio by use of a plurality of load ratio counters with attention focused on changes in the display load ratio over consecutive frames, and that reduces sustain frequency when there is a risk of thermal damage or burning. In these technologies, provision is made to reduce the total light emitting pulse count upon determining that there is a risk of thermal damage or burning, so that the total light emitting pulse count drops from a predetermined pulse count n that is given as a function of a display load ratio having characteristics as illustrated in FIG. 5.

The reduction of a total light emitting pulse count as disclosed in Patent Document 1 and Patent Document 2 that reduces the total light emitting pulse count from a predetermined pulse count given as a function of a display load ratio, however, may create a visually noticeable luminance change of the darkening display, or may create a sensation of the display being dark.

[Patent Document 1] Japanese Patent Application Publication No. 2002-99242

[Patent Document 2] Japanese Patent Application Publication No. 2004-045886

### Disclosure of Invention

### Problem to be Solved by Invention

In consideration of the above, it is an object of the present invention to provide a plasma display apparatus that can suppress a luminance drop in the screen display when the total light emitting pulse count is reduced from a predetermined pulse count given as a function of a display load ratio.

### Means to Solve the Problem

A plasma display apparatus includes a plasma display panel having a plurality of sustain electrodes and a plurality of scan electrodes, a driver circuit to apply sustain pulses to the plurality of sustain electrodes and the plurality of scan electrodes to generate sustain discharges, and a control circuit to control the driver circuit such that a total light emitting pulse count defined as a total number of sustain pulses in one display frame is set equal to a predetermined pulse count defined as a function of a display load ratio, and such that the total light emitting pulse count is set lower than the predetermined pulse count upon detecting a predetermined condition, wherein the control circuit is configured to cause the driver circuit to selectively generate first sustain pulses with timing for clamping to a predetermined voltage being first timing and second sustain pulses with timing for clamping to the predetermined voltage being second timing, and configured to cause a ratio between a number of the first sustain pulses and a number of the second sustain pulses to be different between a case of the total light emitting pulse count being the predetermined pulse count and a case of the total light emitting pulse count being smaller than the predetermined pulse count.

In a plasma display apparatus which includes a plasma display panel having a plurality of sustain electrodes and a plurality of scan electrodes, a driver circuit to apply sustain pulses to the plurality of sustain electrodes and the plurality of scan electrodes to generate sustain discharges, and a control circuit to control the driver circuit such that a total light emitting pulse count defined as a total number of sustain pulses in one display frame is set equal to a predetermined pulse count defined as a function of a display load ratio, and such that the total light emitting pulse count is set lower than the predetermined pulse count upon detecting a predetermined condition, a method of driving a plasma display panel includes the steps of causing the driver circuit to selectively generate first sustain pulses with timing for clamping to a predetermined voltage being first timing and second sustain pulses with timing for clamping to the predetermined voltage being second timing, setting a ratio between the number of the first sustain pulses and the number of the second sustain pulses to a first ratio in a case of the total light emitting pulse count being the predetermined pulse count, and setting a ratio between the number of the first sustain pulses and the number of the second sustain pulses to a second ratio different from the first ratio in a case of the total light emitting pulse count being smaller than the predetermined pulse count.

### Advantage of the Invention

According to at least one embodiment of the present invention, provision is made such that the ratio between the number of first sustain pulses and the number of second sustain pulses differs between the case of the total light emitting pulse count being the predetermined pulse count and the case of the total light emitting pulse count being smaller than the predetermined pulse count. In this arrangement, the ratio is controlled to increase the proportion of first sustain pulses upon lowering the total light emitting pulse count from the predetermined pulse count if the first sustain pulses have a higher luminance level. With this arrangement, it is possible to suppress a luminance drop in the screen display when the total light emitting pulse count is reduced from a predetermined pulse count given as a function of a display load ratio.

### BRIEF DESCRIPTION OF DRAWINGS

FIG. 1 is a cross-sectional view of a three-electrode-type flat-plane-discharge AC-PDP panel.

FIG. 2 is a block diagram showing a main part of a driver circuit for the three-electrode-type flat-plane-discharge AC-PDP panel.

FIG. 3 is a waveform diagram showing an example of a basic operation of the driver circuit of FIG. 2.

FIG. 4 is a drawing for explaining a method of displaying gray scales based on a sub-frame method.

FIG. 5 is a drawing illustrating the relationship of a total light emitting pulse count and power consumption with a display load ratio.

FIG. 6 is a drawing illustrating an example of the configuration of an embodiment of a plasma display apparatus according to the present invention.

FIG. 7 is a drawing illustrating an example of the configuration of a power control unit illustrated in FIG. 6.

FIG. 8 is a drawing illustrating the total light emitting pulse count controlled by a total light emitting pulse count controlling unit.

FIG. 9 is a drawing for explaining a common driver control circuit driving an X common driver circuit.

FIG. 10 is a drawing for explaining the generation of a sustain pulse by the circuit illustrated in FIG. 9.

FIG. 11 is a drawing for explaining the generation of another sustain pulse by the circuit illustrated in FIG. 9.

FIG. 12 is a drawing illustrating an example of the operation that changes the ratio between the number of first sustain pulses and the number of second sustain pulses.

FIG. 13 is a drawing illustrating examples of patterns for which the ratio between the number of first sustain pulses and the number of second sustain pulses are changed.

### DESCRIPTION OF REFERENCE NUMBERS

111 Address Driver Circuit
112 Scan Driver Circuit
113 Y Common Driver Circuit
114 X Common Driver Circuit
115 Control Circuit
116 Display Data Control Unit
117 Scan Driver Control Unit
118 Common Driver Control Unit
119 Frame Memory
120 Power Control Unit
200 Power Control Unit
201 Common Driver Control Unit

### BEST MODE FOR CARRYING OUT THE INVENTION

In the following, embodiments of the present invention will be described with reference to the accompanying drawings.

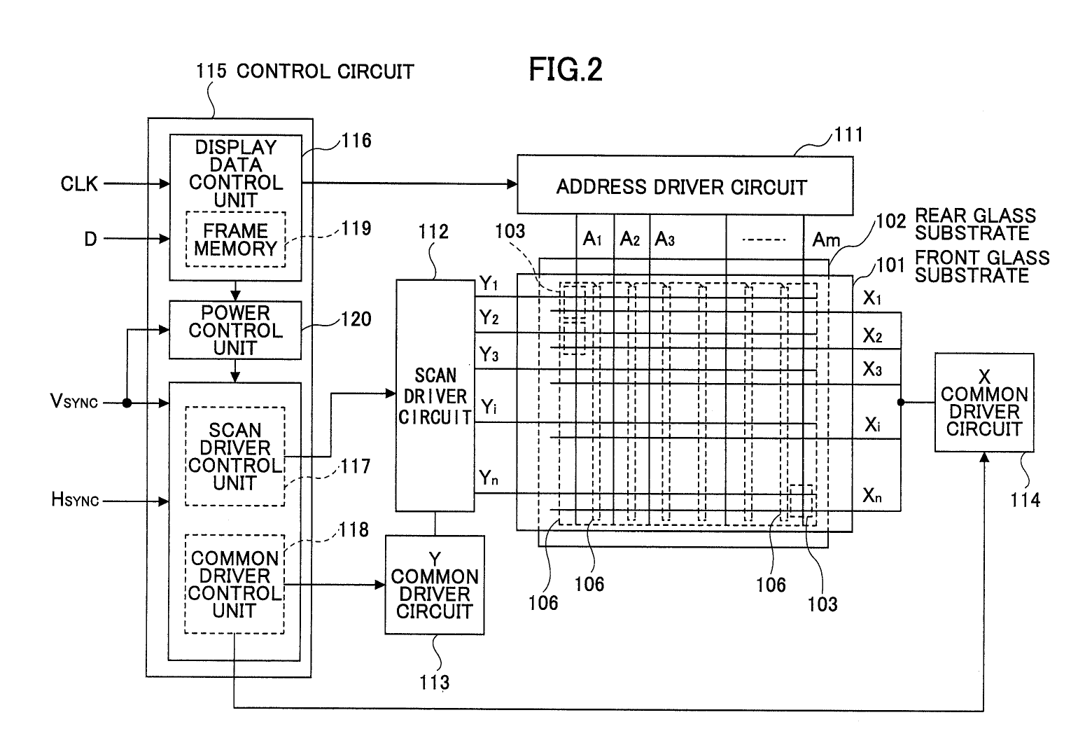

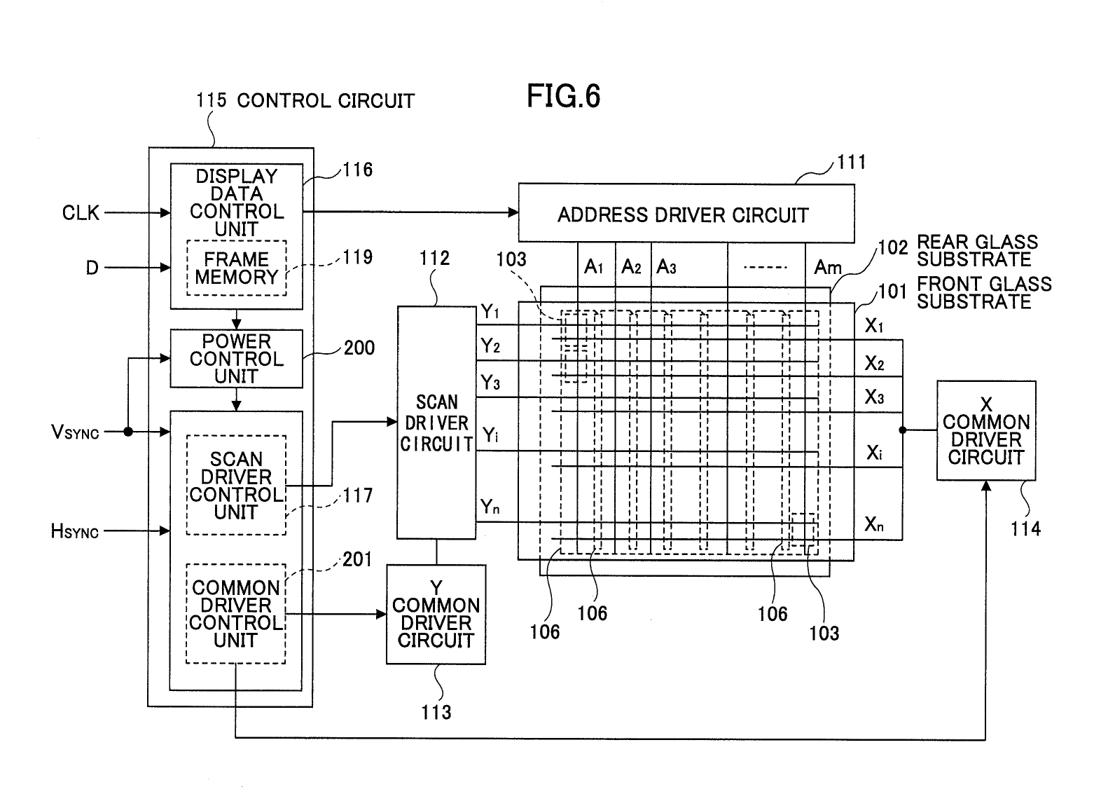

FIG. 6 is a drawing illustrating an example of the configuration of an embodiment of a plasma display apparatus according to the present invention. In FIG. 6, the same elements as those of FIG. 2 are referred to by the same numerals, and a description thereof will be omitted.

The plasma display apparatus illustrated in FIG. 6 differs from the plasma display apparatus of FIG. 2 in the functions of a power control unit 200 and a common driver control unit 201. The power control unit 200 of the control circuit 115 calculates the duration of one frame (i.e., one frame length) based on the vertical synchronizing signal, and also calculates the display load ratio based on display data, followed by calculating a pulse count control parameter based on the calculated frame length and the display load ratio. In so doing, the pulse count control parameter is generated such that the total light emitting pulse count equal to the total number of sustain pulses in one display frame is set equal to a predetermined pulse count defined as a function of a display load ratio. Further, the power control unit 200 controls the pulse count control parameter to reduce the total light emitting pulse count from the above-noted predetermined pulse count upon detecting a predetermined condition indicative of a risk of thermal damage or burning. In the flowing, such control to reduce the total light emitting pulse count is referred to as heat auto power control.

The common driver control unit 201 of the control circuit 115 controls the Y common driver circuit 113 and/or the X common driver circuit 114, such that the timing at which sustain pulses are clamped to a predetermined voltage varies. Through this control, the common driver control unit 201 selectively generates first sustain pulses with the timing for clamping to the predetermined voltage being a first timing and second sustain pulses with the timing for clamping to the predetermined voltage being a second timing.

In the plasma display apparatus illustrated in FIG. 6, the common driver control unit 201 of the control circuit 115 changes a ratio between the number of first sustain pulses and the number of second sustain pulses when the power control unit 200 of the control circuit 115 lowers the total light emitting pulse count from the above-noted predetermined pulse count. Namely, provision is made such that the ratio between the number of first sustain pulses and the number of second sustain pulses differs between the case of the total light emitting pulse count being equal to the predetermined pulse count and the case of the total light emitting pulse count being smaller than the predetermined pulse count. In this arrangement, the ratio is controlled to increase the proportion of first sustain pulses upon lowering the total light emitting pulse count from the predetermined pulse count if the first sustain pulses have a higher luminance level. With this arrangement, it is possible to suppress a luminance drop in the screen display when the total light emitting pulse count is reduced from a predetermined pulse count given as a function of a display load ratio.

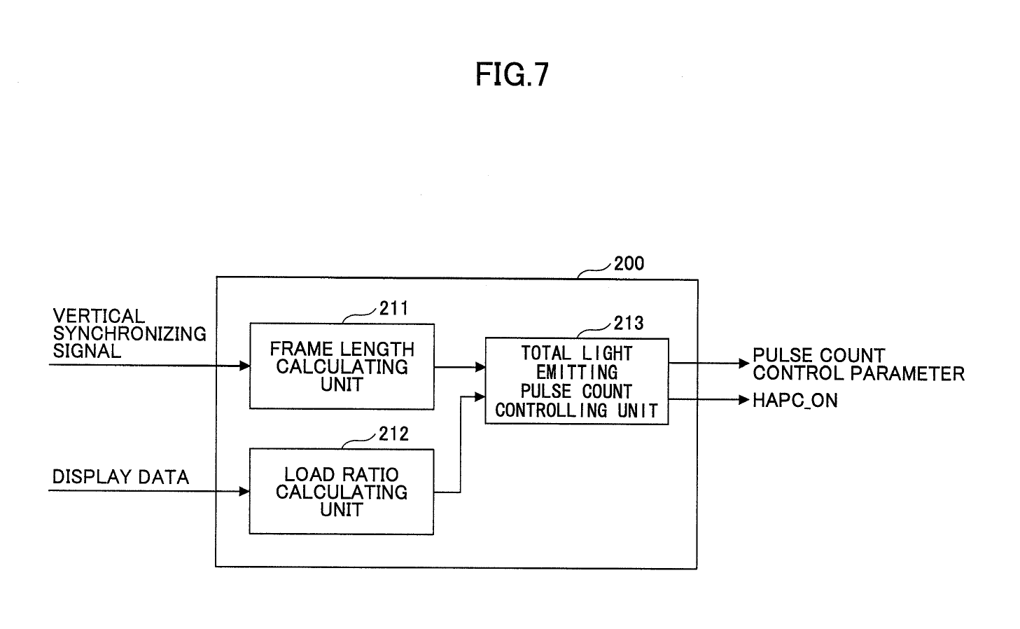

FIG. 7 is a drawing showing an example of the configuration of the power control unit 200. The power control unit 200 includes a frame length calculating unit 211, a load ratio calculating unit 212, and a total light emitting pulse count controlling unit 213. The frame length calculating unit 211 calculates the duration of one frame (i.e., one frame length) from the vertical synchronizing signal (V_{SYNC} in FIG. 6). The load ratio calculating unit 212 calculates the display load ratio from display data (D in FIG. 6). The display data control unit 116 illustrated in FIG. 6 stores the input display data D in the frame memory 119 after converting the data D into data indicative of the lit/unlit state of each pixel for each sub-frame.

The display load ratio may be calculated by detecting the display light emitting pulse count by counting the light emitting pixels for each sub-frame in this converted data and by calculating a ratio of this display light emitting pulse count to the maximum light emitting pulse count.

The total light emitting pulse count controlling unit 213 calculates the pulse count control parameter from the one frame length and the display load ratio obtained through the above-noted calculations. Based on this pulse count control parameter, the common driver control unit 201 controls the operation of generating sustain pulses. In so doing, the total light emitting pulse count controlling unit 213 generates the pulse count control parameter, such that the total light emitting pulse count equal to the total number of sustain pulses in one display frame is set equal to a predetermined pulse count defined as a function of a display load ratio. It should be noted that the number of sustain pulses per unit time, i.e., sustain frequency, rather than the number of sustain pulses in one frame, is typically used as the pulse count control parameter. In order to obtain the sustain frequency, information about one frame length from the frame length calculating unit 211 is used. If the total light emitting pulse count is alternatively used as the parameter for control, there is no need to use the information about one frame length. In such a case, the frame length calculating unit 211 is not necessary. The ultimate object, which is to control the total light emitting pulse count, is the same regardless of which one of the sustain frequency and the total light emitting pulse count is used as the pulse count control parameter.

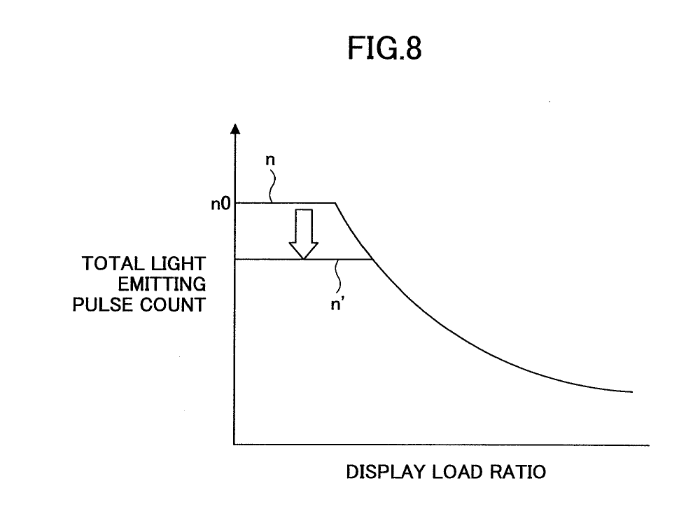

FIG. 8 is a drawing illustrating the total light emitting pulse count controlled by the total light emitting pulse count controlling unit 213. As illustrated in FIG. 8, the control of the total light emitting pulse count (i.e., the adjustment of the pulse count control parameter) is performed such that the total light emitting pulse count is set equal to a predetermined pulse count n defined as a function of a display load ratio. Further, the power control unit 200 controls the total light emitting pulse count to lower the total light emitting pulse count from the above-noted predetermined pulse count n to a pulse count n′ upon detecting a predetermined condition indicative of a risk of thermal damage and/or burning. The predetermined condition noted above may be a condition in which a state of the display load ratio being lower than a predetermined threshold continues more than a predetermined period, or may be a condition in which a state of the display load ratio falling within a predetermined range occurs more frequently than a predetermined frequency. Specific examples of such detection conditions are disclosed in Patent Document 1 and Patent Document 2 previously described.

The total light emitting pulse count controlling unit 213 asserts a signal HAPCON indicative of an ON state of heat auto power control when the ON state of heat auto power control has resulted in the total light emitting pulse count being lowered from the predetermined pulse count defined as a function of a display load ratio. In response to the assertion of the signal HAPCON, the common driver control unit 201 changes the ratio between the number of first sustain pulses and the number of second sustain pulses as previously described.

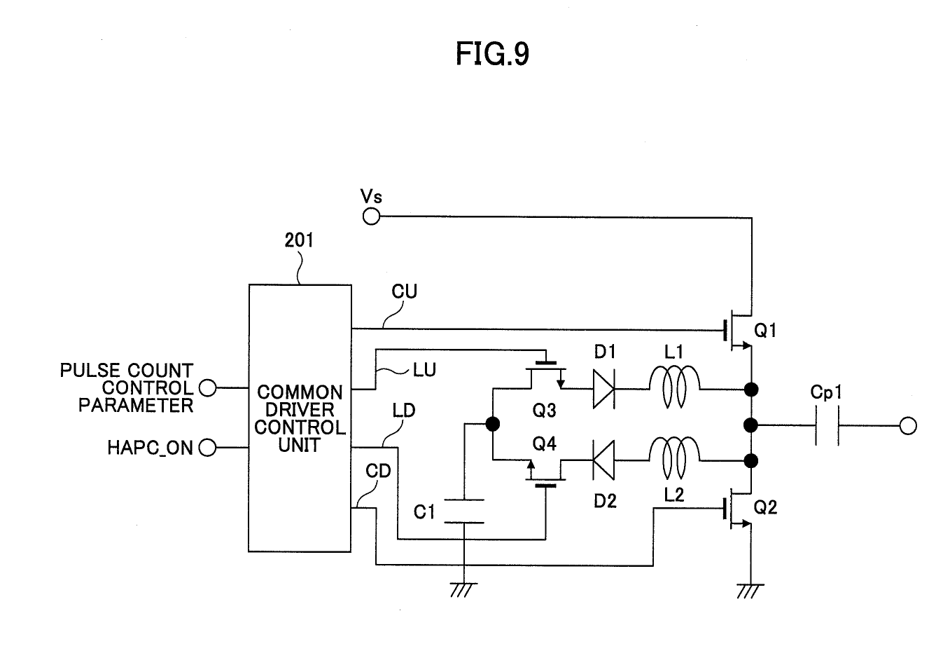

FIG. 9 is a drawing for explaining the common driver control unit 201 driving the X common driver circuit 114. In FIG. 9, a capacitor Cp1 represents the plasma display panel by use of an equivalent capacitance, which is an inter-electrode capacitance between the X electrodes and the remaining electrodes (e.g., Y electrodes). A circuit comprised of power MOS-field-effect transistors Q1 through Q4, diodes D1 and D2, inductors L1 and L2, and a charge-collection-purpose condenser C1 corresponds to a sustain circuit portion of the X common driver circuit 114 that generates sustain discharge. The X common driver circuit 114 further includes circuit portions for supplying the reset voltage and the like, which are omitted in FIG. 9. Further, a sustain circuit portion of the Y common driver circuit 113 illustrated in FIG. 6 that generates sustain discharge has a configuration substantially the same as the circuit illustrated in FIG. 9.

In the initial state of a sustain discharge operation, the capacitor Cp1 has no electric charge accumulated therein and is placed at the ground potential while the charge-collection-purpose condenser C1 has accumulated electric charge to exhibit a voltage of about Vs/2. In this state, the power MOS-field-effect transistor Q3 becomes conductive, so that the electric charge of the charge-collection-purpose condenser C1 flows into the capacitor Cp1 via the diode D1 and the inductor L1. When this happens, the capacitor Cp1 exhibits a voltage of about VS0 through the resonance of the inductor L1 and the capacitor Cp1. Thereafter, in order to clamp the X electrodes of the plasma display panel to Vs to maintain a constant voltage, the power MOS-field-effect transistor Q1 is turned on to supply the voltage Vs to the X electrodes. Consequently, sustain discharge is generated.

After this, the power MOS-field-effect transistor Q1 is turned off, and the power MOS-field-effect transistor Q4 is turned on, so that electric charge flows into the charge-collection-purpose condenser C1 from the capacitor Cp1 via the inductor L2 and the diode D2. With this arrangement, the electric charge that has been used to charge the capacitor Cp1 of the plasma display panel can be collected. During the collection of electric charge, the resonance of the inductor L2 and the capacitor Cp1 is utilized. The power MOS-field-effect transistor Q2 is then turned on to remove the electric charge of Cp1 remaining after the collection, thereby clamping the X electrodes to the ground potential.

The control terminal voltages (i.e., gate voltages) of the power MOS-field-effect transistors Q1 through Q4 are controlled by the common driver control unit 201. The common driver control unit 201 generates control signals CU, CD, LU, and LD based on the pulse count control parameter supplied from the power control unit 200 and the signal HAPCON indicative of an ON state of heat auto power control. The control signals CU, CD, LU, and LD are applied to the control terminals of the power MOS-field-effect transistors Q1, Q2, Q3, and Q4, respectively.

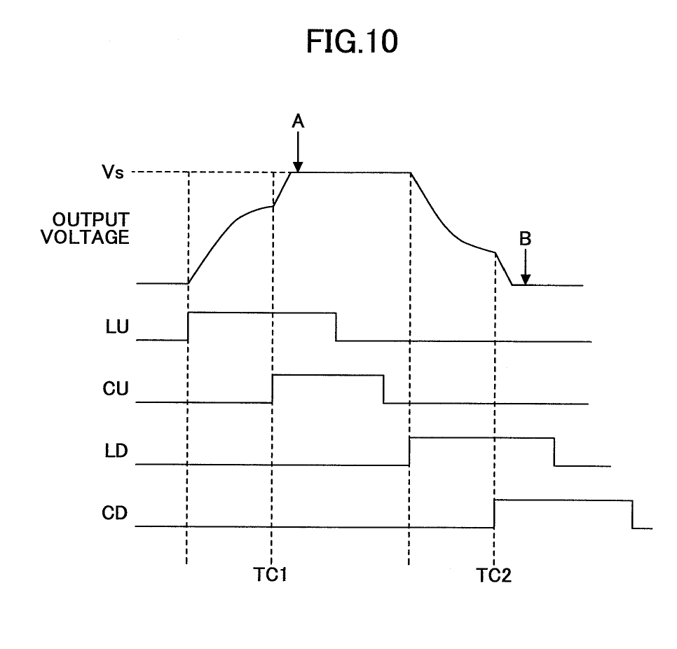

FIG. 10 is a drawing for explaining the generation of a sustain pulse by the circuit illustrated in FIG. 9. In FIG. 10, an output voltage of the X common driver circuit 114 (i.e., the voltage at the connection point between the series-connected transistors Q1 and Q2) is illustrated at the top. The horizontal axis represents passage of time. The control signal LD is set to HIGH first, which causes the output voltage to rise according to a resonance oscillation waveform due to the resonance of the inductor L1 and the capacitor Cp1. When the output voltage waveform comes close to its maximum peak, the control signal CU is set to HIGH at clamp timing TC1 to clamp the output voltage to Vs. The timing indicated by an arrow A may be discharge timing. With this discharge timing, electric discharge occurs after the sustain pulse is clamped to the sustain voltage Vs. In such a case, the electric discharge occurs with a relatively high voltage between the electrodes, thereby providing relatively high luminance display.

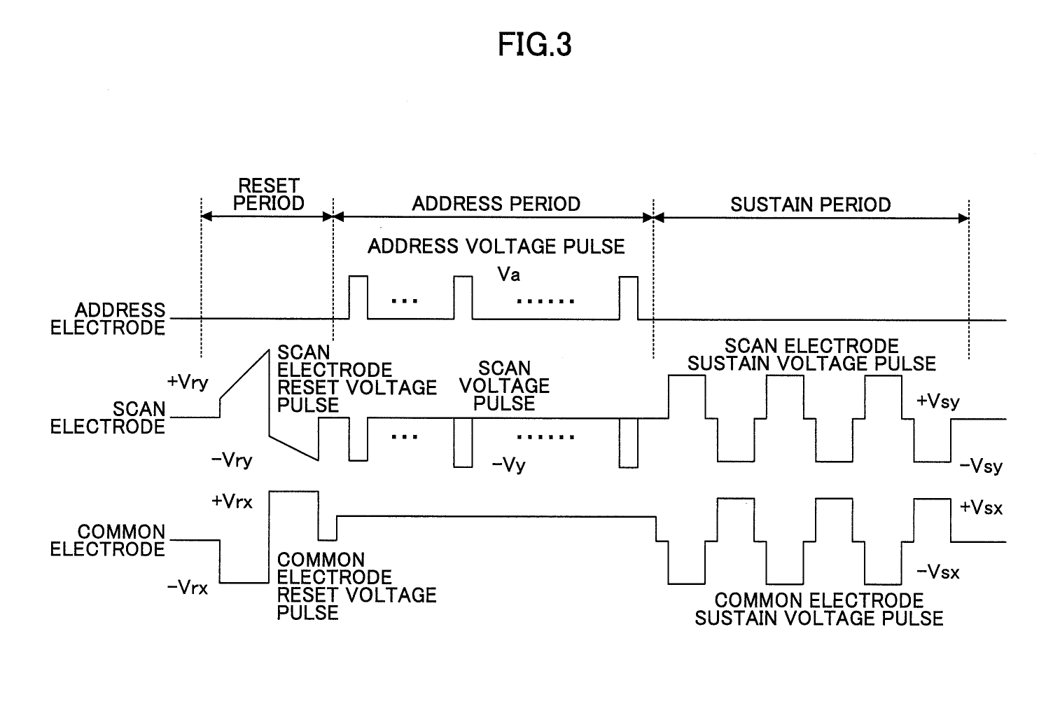

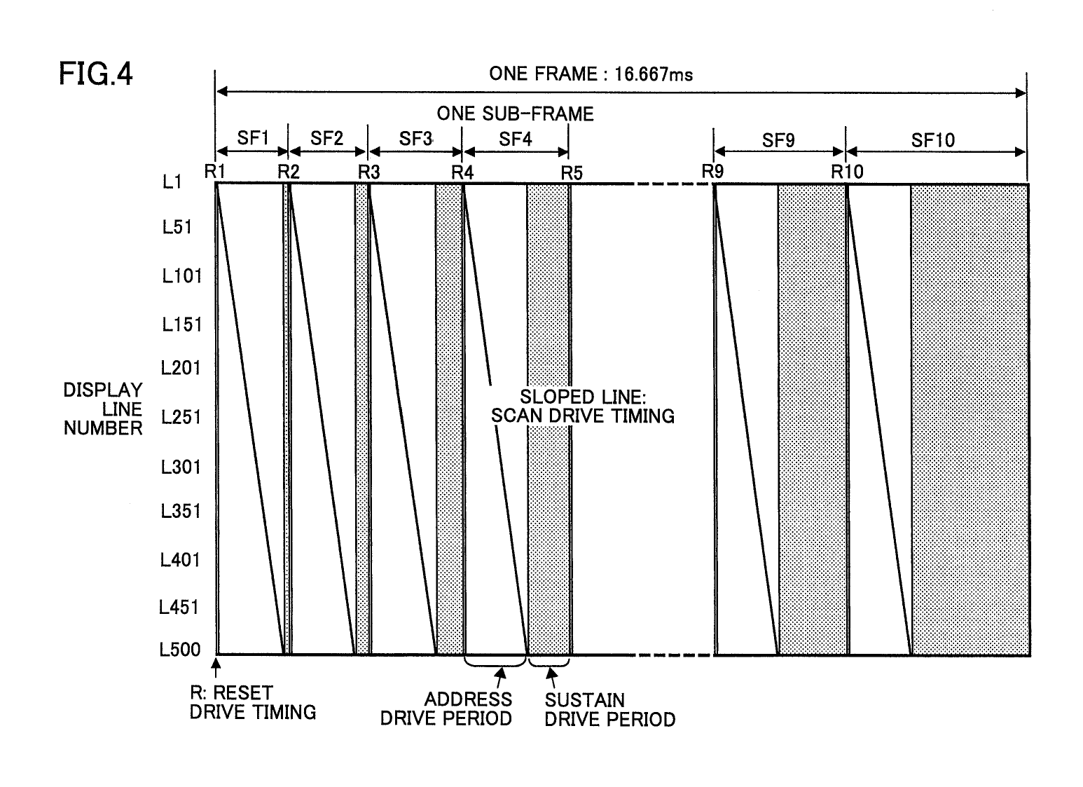

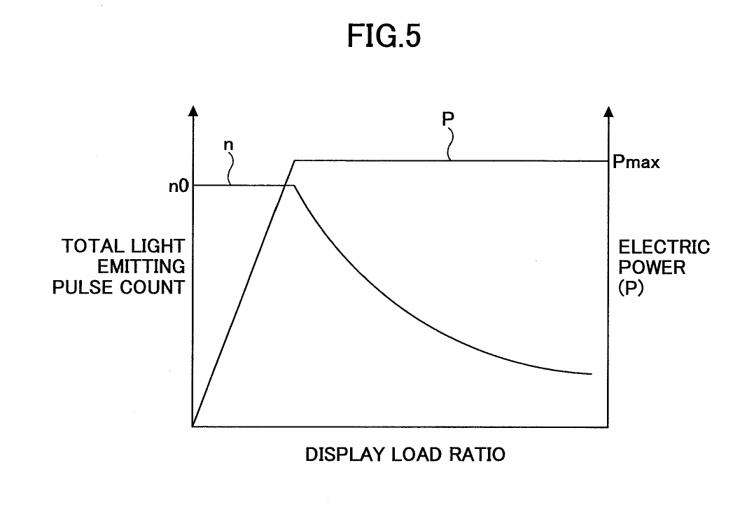

After this, the control signal LD is set to HIGH after setting the control signals LU and CU to LOW, which causes the output voltage to drop according to a resonance oscillation waveform due to the resonance of the inductor L2 and the capacitor Cp1. When the output voltage waveform comes close to its minimum peak, the control signal CD is set to HIGH at clamp timing TC2 to clamp the output voltage to the ground potential. The timing indicated by an arrow B may be discharge timing. With this discharge timing, electric discharge occurs after the sustain pulse is clamped to the ground voltage. In such a case, the electric discharge occurs with a relatively high voltage between the electrodes, thereby providing relatively high luminance display. It should be noted that this example is directed to a case in which pulses overlap between adjacent electrodes as illustrated in FIG. 3, in which a sustain pulse of the Y electrodes has already become HIGH by the time a sustain pulse of the X electrodes becomes LOW.

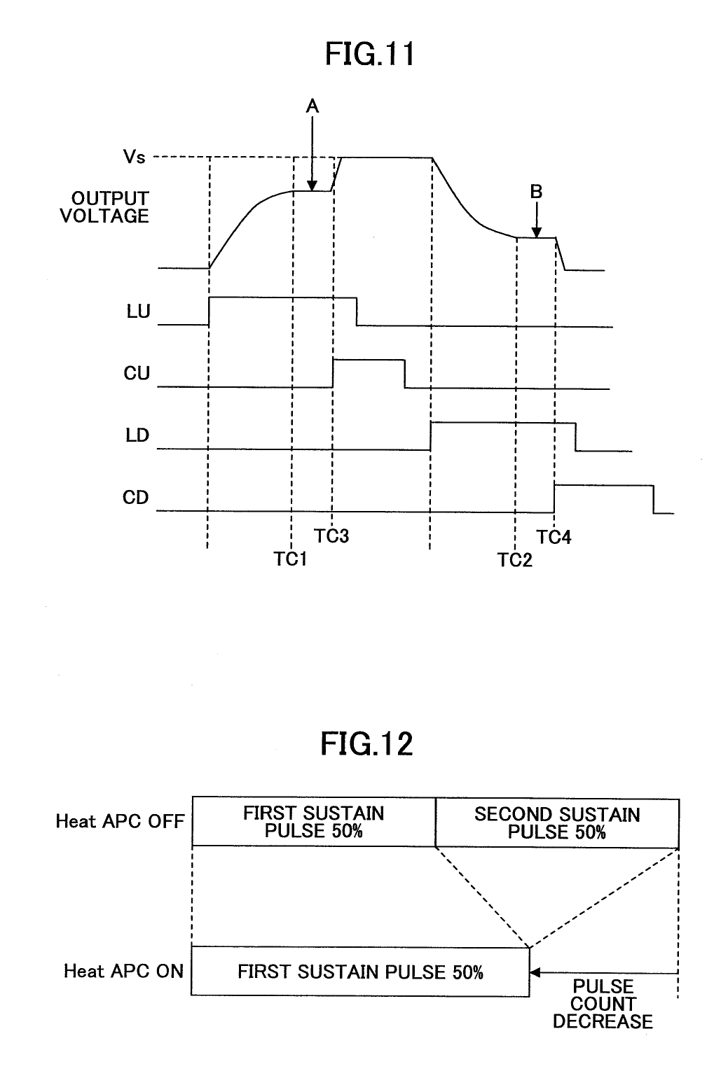

FIG. 11 is a drawing for explaining the generation of another sustain pulse by the circuit illustrated in FIG. 9. In FIG. 11, the output voltage is not immediately clamped upon reaching its maximum peak according to the resonance oscillation waveform due to the resonance between the inductor L1 and the capacitor Cp1, but is maintained at the peak voltage for a while due to the function of the diode D1 illustrated in FIG. 9. After this, the control signal CU is set to HIGH at clamp timing TC3 to clamp the output voltage to Vs. The timing indicated by an arrow A may be discharge timing. With this discharge timing, electric discharge occurs before the sustain pulse is clamped to the sustain voltage Vs. In such a case, the electric discharge occurs with a relatively low voltage between the electrodes, thereby providing relatively low luminance display.

After this, the control signal LD is set to HIGH after setting the control signals LU and CU to LOW, which causes the output voltage to drop according to a resonance oscillation waveform due to the resonance of the inductor L2 and the capacitor Cp1. The output voltage is not immediately clamped upon reaching its minimum peak, but is maintained at the peak voltage for a while due to the function of the diode D2 illustrated in FIG. 9. After this, the control signal CD is set to HIGH at clamp timing TC4 to clamp the output voltage to the ground potential. The timing indicated by an arrow B may be discharge timing. With this discharge timing, electric discharge occurs before the sustain pulse is clamped to the ground voltage. In such a case, the electric discharge occurs with a relatively low voltage between the electrodes, thereby providing relatively low luminance display. It should be noted that this example is directed to a case in which pulses overlap between adjacent electrodes as illustrated in FIG. 3, in which a sustain pulse of the Y electrodes has already become HIGH by the time a sustain pulse of the X electrodes becomes LOW.

The common driver control unit 201 illustrated in FIG. 9 controls the number of sustain pulses (or frequency) generated by the driver circuits in response to the pulse count control parameter. Through this control, the total light emitting pulse count is set equal to the predetermined pulse number n (see FIG. 8) defined as a function of a display load ratio, unless a predetermined condition indicative of a risk of thermal damage or burning is detected. Through this control, further, the total light emitting pulse count is lowered from the above-noted predetermined pulse count n to the pulse count n′ (see FIG. 8) upon detecting the predetermined condition indicative of a risk of thermal damage or burning.

In response to the assertion of the signal HAPC_ON indicative of an ON state of heat auto power control, the common driver control unit 201 changes the ratio between the number of first sustain pulses with the clamp timing as illustrated in FIG. 10 and the number of second sustain pulses with the clamp timing as illustrated in FIG. 11. Specifically, the proportion of the first sustain pulses by which electric discharge occurs after the clamp timing as illustrated in FIG. 10 is increased, and the proportion of the second sustain pulses by which electric discharge occurs before the clamp timing as illustrated in FIG. 11 is decreased. With such ratio change, a drop of the luminance level upon the reduction of the total light emitting pulse count can be suppressed.

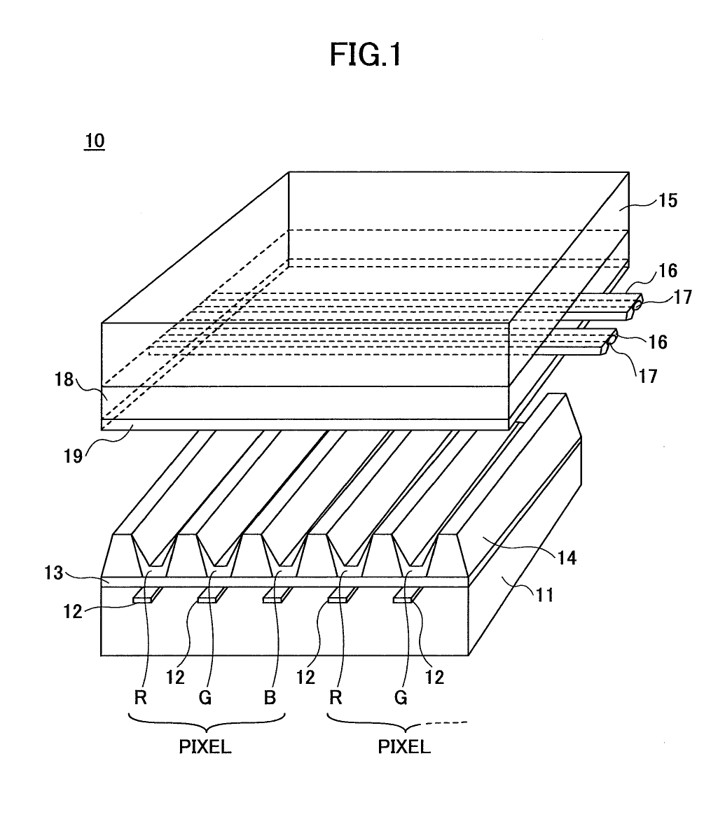

In the case of the plasma display apparatus according to the embodiment of the present invention, the underlying assumption is that the second sustain pulses account for some proportion of the sustain pulses for generating sustain discharge in a state prior to the ON state of heat auto power control. The second sustain pulses are known to have higher light emission efficiency than do the first sustain pulses. It is thus preferable to use some proportion of second sustain pulses in a normal state (i.e., the state in which heat auto power control is OFF). In the normal state, all the sustain pulses may be the second sustain pulses. Moreover, the first sustain pulses may damage the protective layer 19 such as MgO illustrated in FIG. 1 due to their strong ion emission. In this sense, also, it is preferable to use some proportion of second sustain pulses in the normal state.

FIG. 12 is a drawing illustrating an example of the operation that changes the ratio between the number of first sustain pulses and the number of second sustain pulses. In FIG. 12, the proportion of the number of first sustain pulses and the proportion of the number of second sustain pulses are both 50% in an OFF state of heat auto power control (Heat APC). In the ON state of heat auto power control (Heat APC), the total number of sustain pulses decreases as indicated by an arrow, and all the sustain pulses remaining after the decrease are first sustain pulses.

There are several ways to change the ratio between the number of first sustain pulses and the number of second sustain pulses. Any methods may be used among a method of decreasing only the second sustain pulses in order to decrease the total number of sustain pulses, a method of deceasing both the first sustain pulses and the second sustain pulses while changing the ratio in the remaining pulses, and a method of decreasing the second sustain pulses while increasing the first sustain pulses.

As for a method of allocating the first sustain pulses and the second sustain pulses, the first sustain pulses and the second sustain pulses may be used according to a preset ratio in each sub-frame, for example. Namely, in the case of the ratio of the number of first sustain pulses and the number of second sustain pulses being 50:50 as illustrated in FIG. 12, the first half of all the sustain pulses may be the first sustain pulses, and the second half may be the second sustain pulses for each sub-frame. Alternatively, a predetermined number of sustain pulses is treated as one set, and a predetermined ratio of first sustain pulses and second sustain pulses may be used in each set. Namely, in the case of the ratio being 50:50 with 6 sustain pulses constituting one set, three first sustain pulses and three second sustain pulses may be included in each set.

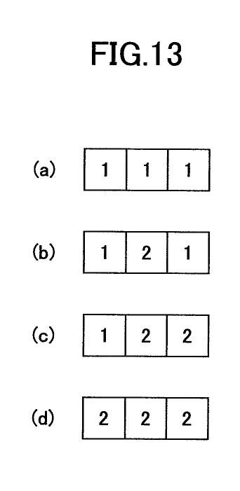

FIG. 13 is a drawing illustrating examples of patterns for which the ratio between the number of first sustain pulses and the number of second sustain pulses are changed. In FIG. 13, (a) illustrates a pattern in which the sustain pulses that are the first through third in sequence are the first sustain pulses. (b) illustrates a pattern in which the sustain pulses that are the first in sequence and the third in sequence among the three sustain pulses are the first sustain pulses, and the sustain pulse that is the second in sequence is the second sustain pulse. (c) illustrates a pattern in which the sustain pulse that is the first in sequence among the three sustain pulses is the first sustain pulse, and the sustain pulses that are the second in sequence and the third in sequence are the second sustain pulses. (c) illustrates a pattern in which the sustain pulses that are the first through third in sequence are the first sustain pulses. The patterns illustrated in (a), (b), (c), and (d) achieve the proportion of first sustain pulses that is 100%, 67%, 33%, and 0%, respectively. In this manner, a predetermined number of sustain pulses may be treated as one set, and a predetermined ratio of first sustain pulses and second sustain pulses may be used in each set.

Although the first timing (TC1, TC2) as illustrated in FIG. 10 and the second timing (TC3, TC4) as illustrated in FIG. 11 have been used as clamp timings in the description given above, the clamp timings are not limited to these two. For example, third timing in which clamping is performed between TC1 and TC3 on a rise transition of the pulse, and is performed between TC2 and TC4 on a fall transition of the pulse may be used in addition to the first timing and the second timing. In such a case, the first sustain pulses with the first clamp timing, the second sustain pulses with the second clamp timing, and the third sustain pulses with the third clamp timing may be used together, with their ratio being changed between the ON state and OFF state of heat auto power control. The proportion of sustain pulses that have a high discharge voltage to provide a high luminance level may be increased in the ON state of heat auto power control. Alternatively, the second sustain pulses with the second clamp timing and the third sustain pulses with the third clamp timing may be used together, with their ratio being changed between the ON state and OFF state of heat auto power control. In this case also, the proportion of sustain pulses (third sustain pulses) that have a high discharge voltage to provide a high luminance level may be increased in the ON state of heat auto power control.

Further, the present invention is not limited to these embodiments, but various variations and modifications may be made without departing from the scope of the present invention.

1. A plasma display apparatus, comprising:
a plasma display panel having a plurality of sustain electrodes and a plurality of scan electrodes;
a driver circuit to apply sustain pulses to the plurality of sustain electrodes and the plurality of scan electrodes to generate sustain discharges; and
a control circuit to control the driver circuit such that a total light emitting pulse count defined as a total number of sustain pulses in one display frame is set equal to a predetermined pulse count defined as a function of a display load ratio, and such that the total light emitting pulse count is set lower than the predetermined pulse count upon detecting a predetermined condition,
wherein the control circuit is configured to cause the driver circuit to selectively generate first sustain pulses with timing for clamping to a predetermined voltage being first timing and second sustain pulses with timing for clamping to the predetermined voltage being second timing, and configured to cause a ratio between a number of the first sustain pulses and a number of the second sustain pulses to be different between a case of the total light emitting pulse count being the predetermined pulse count and a case of the total light emitting pulse count being smaller than the predetermined pulse count.

2. The plasma display apparatus as claimed in claim 1, wherein the first timing is timing at which clamping to the predetermined voltage occurs before an occurrence of sustain discharge, and the second timing is timing at which clamping to the predetermined voltage occurs after an occurrence of sustain discharge.

3. The plasma display apparatus as claimed in claim 2, wherein a proportion of the number of first sustain pulses in the total number of sustain pulses is larger in the case of the total light emitting pulse count being smaller than the predetermined pulse count, than in the case of the total light emitting pulse count being the predetermined pulse count.

4. The plasma display apparatus as claimed in claim 1, wherein the predetermined condition is a condition in which there is a risk of thermal damage and/or burning with respect to the plasma display panel.

5. The plasma display apparatus as claimed in claim 1, wherein the control circuit is configured to cause the driver circuit to selectively generate third sustain pulses with timing for clamping to the predetermined voltage being third timing in addition to the first sustain pulses and the second sustain pulses.

6. A method of driving a plasma display panel in a plasma display apparatus which includes
a plasma display panel having a plurality of sustain electrodes and a plurality of scan electrodes,
a driver circuit to apply sustain pulses to the plurality of sustain electrodes and the plurality of scan electrodes to generate sustain discharges, and
a control circuit to control the driver circuit such that a total light emitting pulse count defined as a total number of sustain pulses in one display frame is set equal to a predetermined pulse count defined as a function of a display load ratio, and such that the total light emitting pulse count is set lower than the predetermined pulse count upon detecting a predetermined condition, said method comprising the steps of:
causing the driver circuit to selectively generate first sustain pulses with timing for clamping to a predetermined voltage being first timing and second sustain pulses with timing for clamping to the predetermined voltage being second timing,
setting a ratio between the number of the first sustain pulses and the number of the second sustain pulses to a first ratio in a case of the total light emitting pulse count being the predetermined pulse count; and
setting a ratio between the number of the first sustain pulses and the number of the second sustain pulses to a second ratio different from the first ratio in a case of the total light emitting pulse count being smaller than the predetermined pulse count.

7. The method of driving a plasma display panel as claimed in claim 6, wherein the first timing is timing at which clamping to the predetermined voltage occurs before an occurrence of sustain discharge, and the second timing is timing at which clamping to the predetermined voltage occurs after an occurrence of sustain discharge.

8. The method of driving a plasma display panel as claimed in claim 7, wherein a proportion of the number of first sustain pulses in the total number of sustain pulses is larger in the second ratio than in the first ratio.

9. The method of driving a plasma display panel as claimed in claim 6, wherein the predetermined condition is a condition in which there is a risk of thermal damage and/or burning with respect to the plasma display panel.
